(19) United States
(12) Patent Application Publication
(10) Pub. No.: US 2004/0132948 A1
(43) Pub. Date: Jul. 8, 2004

(54) Organic/inorganic composite optical material and optical element

(75) Inventor: Michio Shirai, Tokyo (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/737,998

(22) Filed: Dec. 18, 2003

(30) Foreign Application Priority Data
Dec. 18, 2002 (JP) 2002-366938

(51) Int. Cl. C08G 77/04

(52) U.S. Cl. 528/25; 528/27; 528/28

(57) ABSTRACT

The present invention is directed to provide an organic/inorganic composite optical material and an optical element in which organic component and inorganic component are in good dispersed state and which has excellent optical characteristics. The organic/inorganic composite optical material comprises an organic high-molecular substance and an inorganic polymer which is prepared by the polycondensation of a metal alkoxide compound, and is characterized in that the metal alkoxide compound includes a functional group capable of interacting with the organic high-molecular substance or a monomer/oligomer generating the organic high-molecular substance to form a chemical bond therebetween.

### BACKGROUND OF THE INVENTION

The present invention relates to an organic/inorganic composite optical material comprising an organic high-molecular substance and an inorganic polymer which is prepared by polycondensation of a metal alkoxide compound and relates to an optical element made of the same.

As synthetic resin materials for optical application, thermoplastic resins such as polymethyl methacrylate (PMMA), polycarbonate (PC), amorphous polyolefin (APO), and polystyrene (PS), and thermosetting resins such as diethylene glycol bis (allyl carbonate) polymer are employed. Optical elements such as lenses and prisms are made of these materials. These synthetic resins each have a coefficient of linear thermal expansion on the order of 10⁻⁵ or more, and a thermal expansion coefficient which is over one digit larger than that of an optical glass, and, similarly, a larger temperature dependency of refractive index.

Moreover, these synthetic resins each have a relatively low glass-transition temperature (Tg). Therefore, there is a problem that its linear characteristic of thermal property varies at the glass-transition temperature and its kinetic property deteriorates at a temperature higher than the glass-transition temperature.

When these organic high-molecular substances are employed to make optical components which are designed according to the optical technology with a high degree of accuracy, for example, a non-spherical lens, a diffraction optical element, and an optical element having a free-form surface, there is a problem that the dimensional accuracy varies due to variation in temperature so that the optical accuracy cannot be limited within the allowable range.

To prevent the thermal expansion of an optical material consisting of an organic high-molecular substance, there has been proposed an optical material consisting of an organic/inorganic composite material in which inorganic particles are dispersed in synthetic resin, for example, as disclosed in JP(A) 4-254406.

Further, there has been proposed a method of producing an organic/inorganic composite material having smaller thermal expansion of synthetic resin by performing the hydrolysis polycondensation of a metal alkoxide compound in the presence of a synthetic-resin monomer and then polymerizing the synthetic-resin monomer, for example, as disclosed in JP(A) 8-157735.

Further, there has been proposed a method of producing an organic/inorganic composite material having excellent heat resistance by mixing an alkoxytitanium and a hardener into an epoxy resin, for example, as disclosed in JP(A) 2000-319362.

However, when inorganic fine particles are dispersed in a synthetic resin, the inorganic fine particles of which diameters are small may agglutinate. Accordingly, there is a high probability of generating portions where the dispersion of inorganic fine particles is insufficient. In case of applying optical elements, there is a possible problem of generating significant light scattering.

When the polycondensation of a metal alkoxide compound is carried out in the presence of a monomer of polymerizable organic compound, well dispersed state between organic component and inorganic component can be obtained so as to inhibit the light scattering. As for the synthetic resin, the larger the molecular weight, the poorer the solubility relative to a solvent is. Accordingly, the synthetic resin becomes harder to be solved. Therefore, even when an inorganic polymer in uniform state is obtained by polycondensation of the metal alkoxide compound in the presence of the monomer of polymerizable organic compound, the intersolubility between the synthetic resin component and the inorganic polymer component sometimes decreases during polymerization of the monomer to have high molecular weight, thus creating such a dispersed state making the inorganic polymerized component to have optical harmful effects.

Similarly to the case dispersing inorganic fine particles into a synthetic resin, there is a problem that light scattering may occur when the aforementioned organic/inorganic composite material is used to make an optical element so that the optical element can not exhibit the designed optical performance.

It is an object of the present invention to provide an organic/inorganic composite optical material which can be adopted to an optical element having excellent optical characteristics, not allowing such light scattering of the organic/inorganic composite optical material.

### BRIEF DESCRIPTION OF THE DRAWINGS

FIG. 1 is a graph showing a transmittance curve of an organic/inorganic composite optical material of an example,

FIG. 2 is a graph for explaining an observation result by using a stereo microscope of light scattering of the organic/inorganic composite optical material of the example when irradiated with laser beam,

FIG. 3 is a graph showing a transmittance curve of an organic/inorganic composite optical material of a comparative example, and

FIG. 4 is a graph for explaining an observation result by using a stereo microscope of light scattering of the organic/inorganic composite optical material of the comparative example when irradiated with laser beam.

### SUMMARY OF THE INVENTION

The object of the present invention can be achieved by an organic/inorganic composite optical material comprising an organic high-molecular substance and an inorganic polymer which is prepared by the polycondensation of a metal alkoxide compound, wherein the metal alkoxide compound includes a functional group capable of interacting with the organic high-molecular substance or a monomer/oligomer generating the organic high-molecular substance to form a chemical bond therebetween.

In the organic/inorganic composite optical material of the present invention, the organic high-molecular substance and the inorganic polymer as its constituents have functional groups capable of being bonded to each other. Therefore, a chemical bond can be formed between the organic high-molecular substance and the inorganic polymer in the process of conjugating the inorganic polymer and the organic high-molecular substance so as to integrate the organic high-molecular substance and the inorganic polymer, thereby achieving the further homogeneous integral bonding between the organic high-molecular substance and the inorganic polymer.

In the organic/inorganic composite material of the present invention comprising an organic high-molecular substance and a metal alkoxide compound, the metal alkoxide compound may be a metal alkoxide including a functional group capable of interacting with the organic high-molecular substance or a monomer or oligomer generating the organic high-molecular substance to form a chemical bond therebetween, or a metal alkoxide including a functional group capable of interacting with the organic high-molecular substance to achieve integral bonding therebetween, without forming such a bond by chemical reaction with the organic high-molecular substance or a monomer or oligomer of the organic high-molecular substance.

For example, when the organic high-molecular substance has a phenyl group, a metal alkoxide having a phenyl group may be employed. In this case, integral bonding between the organic high-molecular substance and the metal alkoxide can be achieved by aggregation of π(pi)-electron clouds between the phenyl groups.

The present invention also provides an organic/inorganic composite optical material in which the ratio of the molecular weight of the organic functional group relative to the molecular weight of the inorganic polymer prepared by the polycondensation of the metal alkoxide compound is 60% or more.

Since when the ratio of the organic functional group in the inorganic polymer is small, inorganic feature becomes dominant so as to decrease the intersolubility to the organic component so that the resulting organic/inorganic composite optical material has deteriorated optical characteristics such as the light scattering. Accordingly, it is preferable that the ratio of the organic functional group relative to the molecular weight of the inorganic polymer is set to be 60% or more.

Further, the present invention provides an organic/inorganic composite optical material, wherein the organic high-molecular substance is epoxy resin of bisphenol A type and the organic group in the inorganic polymer includes at least one of a glycidyl group, an oxetanyl group, an amino group, a thiocidyl group, a vinyl group, a phenyl group, and an alkyl group.

As the organic high-molecular substance to be used for the preparation of an organic/inorganic composite optical material, various organic high-molecular substances may be employed. By using an epoxy resin of bisphenol A type as the organic high-molecular substance, an organic/inorganic composite optical material having large mechanical strength and large heat resistance can be prepared. By using a reactive functional group such as a glycidyl group, an oxetanyl group, an amino group, a thiocidyl group, and a vinyl group, or alternatively a phenyl group or an alkyl group as the organic group in the inorganic polymer, the intersolubility between the organic high-molecular substance and the inorganic polymer can be improved because of a chemical bond or another interacting effect with the organic high-molecular substance, thereby obtaining an organic/inorganic composite optical material having good optical characteristics. As a result, such organic/inorganic composite optical materials can be used for various applications in a wide variety of fields.

Furthermore, the present invention provides an optical element made of an organic/inorganic composite optical material, wherein the organic/inorganic composite optical material is an organic/inorganic composite optical material as mentioned in the above.

Since the organic/inorganic composite optical material of the present invention has the organic high-molecular substance and the inorganic polymer which are integrated because of the bonding between their functional groups, the optical element made of the organic/inorganic composite optical material is optically excellent.

### DESCRIPTION OF THE PREFERRED EMBODIMENT

Inorganic polymer employed in an organic/inorganic composite optical material of the present invention is an inorganic polymer which has a functional group capable of interacting with an organic high-molecular substance to form a chemical bond such as a covalent bond therebetween. Therefore, the covalent bond is formed between the organic high-molecular substance and the inorganic polymer on molecular level in a process of conjugating the inorganic polymer and the organic high-molecular substance, whereby these molecules are integrally bonded so as to improve the integrity between the organic high-molecular substance and the inorganic polymer.

In addition, the inorganic polymer may be an inorganic polymer including a functional group capable of interacting with the organic high-molecular substance to achieve integral bonding between the inorganic polymer and the organic high-molecular substance, even without forming chemical bond therebetween, thereby improving the intersolubility therebetween.

Examples of the inorganic polymer to be used in the present invention include metal alkoxides such as Si, Ti, Zr, Al, Ba, Ta, Ge, Ga, Cu, Sc, Bi, and lanthanoid, and inorganic polymers having metalloxane backbones prepared by hydrolysis and polycondensation of such a metal alkoxide through the sol-gel reaction or the like.

Examples of the metal alkoxide include silicon alkoxides such as Si(OR)₄ and R¹Si(OR)₃, titaniumalkoxides such as Ti(OR)₄ and R¹Ti(OR)₃, zirconium alkoxides such as Zr(OR)₄, R¹Zr(OR)₃, aluminum alkoxides such as Al(OR)₃ and R¹Al(OR)₂, germanium alkoxides such as Ge(OR)₄ and R¹Ge(OR)₃, barium alkoxides such as Ba(OR)₂, copper alkoxides such as Cu(OR)₂, lanthanum alkoxides such as La(OR)₃, and tantalum alkoxides such as Ta(OR)₅, wherein R represents an alkyl group, R¹ represents a functional group including an alkyl group, a phenyl group, a glycidyl group, an oxetanyl group, an amino group, a thiocidyl group, or a vinyl group.

An inorganic polymer represented by the following Equation 1 is obtained through hydrolysis and polycondensation of a metal alkoxide compound of some of these metal alkoxides using an acid catalyst or a basic catalyst. When a metal alkoxide such as a silicon alkoxide which will impart low refractive index and a metal alkoxide such as a titanium alkoxide or a zirconium alkoxide which will impart high refractive index in the obtained inorganic polymer are combined to form the inorganic polymer, the refractive index and the wavelength dispersion characteristic of the resulting organic/inorganic composite optical material can be adjusted by controlling the mixing proportion between them. Therefore, by using such an organic/inorganic composite optical material, an optical element freely corresponding to the optical design can be obtained.

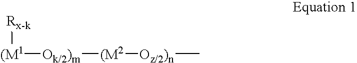

wherein R: an organic group, M¹, M²: metallic atoms of at least one kind or of different kinds, x: the valency of the metallic atom M¹, z: the valency of the metallic atom M², k: an integer higher than 2, m: an integer higher than 1, and n: a positive integer.

In the present invention, in order to bond the organic high-molecular substance and the inorganic polymer, the kind of the reactive functional group of the inorganic polymer is selected corresponding to the kind of the monomer or oligomer generating the organic high-molecular substance to cause the reaction of the organic high-molecular substance, thereby forming a covalent bond between the organic high-molecular substance and the inorganic polymer.

As for the combination of the monomer or oligomer generating the organic high-molecular substance and the reactive functional group of the inorganic polymer, the glycidyl group, oxetanyl group, the thiocidyl group, the amino group, or the isocyanate group is selected in case of forming an epoxy resin, an oxetan resin, or an episulfide resin, the vinyl group, the methacryloyl group, or the thiol group is selected in case of forming an acrylic resin, a methacryl resin, a styrene resin, an unsaturated ester resin or a copolymer resin from these, and the isocyanate group or the hydroxyl group is selected in case of forming an urethane resin.

The functional group of the inorganic polymer may be selected in such a manner as to react with a functional group not directly relating to the high-molecular yielding reaction in the organic high-molecular substance. For example, in case of the epoxy resin having a hydroxyl group on the main chain, an inorganic polymer having an isocyanate group or a Ti—OR (R represents an organic group such as an alkyl group) which can react with the hydroxyl group may be selected.

Alternatively, a chemical structure capable of forming the interaction with π(pi)-electron clouds between phenyl groups, achieving integral bonding similarly to the chemical bonding, because of interaction relative to molecules of the organic high-molecular substance may be employed.

The organic/inorganic composite optical material of the present invention can be obtained as follows. A metal alkoxide compound is added into and mixed with an organic high-molecular substance or a monomer/oligomer generating an organic high-molecular substance, further a catalyst for promoting the high-molecular yielding reaction, water for promoting the hydrolysis of the metal alkoxide compound, and a catalyst for promoting the hydrolysis and polycondensation reaction of the metal alkoxide compound are added into and mixed with the mixture, and the high-molecular yielding reaction and the hydrolysis and polycondensation reaction of the metal alkoxide compound are carried out under the predetermined hardening conditions, thereby making a transparent solid matter.

Instead of adding the metal alkoxide compound before the hydrolysis and polycondensation of the metal alkoxide compound, an inorganic polymer may be previously obtained by the hydrolysis and polycondensation reaction of the metal alkoxide compound and may be mixed with the organic high-molecular substance or the monomer/oligomer generating the organic high-molecular substance.

In this manner, the organic/inorganic composite optical material in which the inorganic polymer and the organic high-molecular substance are covalently bonded to each other can be obtained.

However, the intersolubility between the inorganic polymer component and the synthetic resin component may deteriorate according to the kind of the organic group belonging to the inorganic polymer. In this case, there is a possibility of decrease in transparency of the obtained solid matter.

Therefore, the ratio of the organic group in the inorganic polymer, i.e. the ratio of the molecular weight of the organic group relative to the molecular weight of the inorganic polymer, is set to be 60% or more, thereby improving the intersolubility between the inorganic polymer and the organic high-molecular substance and thus always obtaining a solid matter having good transparency.

Metalloxane backbone (M-O-M: M is a metallic atom) forming the main chain backbone of the inorganic polymer has originally poor intersolubility relative to the organic high-molecular substance. However, improvement of intersolubility of the inorganic polymer phenomenon may be attributed to the fact that the metalloxiane backbone of the inorganic polymer contains an organic group having a similar structure as the chemical structure of the organic high-molecular substance or an organic group causing interaction on the molecular level as a hydrogen bond.

The ratio of the molecular weight of the organic group per the unit molecular weight of the inorganic polymer used here is represented by “Rm/M” where (M) is the unit molecular weight of a molecular structure represented by the following Equation 1 and Rm is the total molecular weight of organic group R contained in this molecular structure.

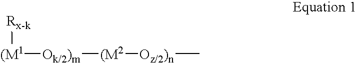

wherein R: an organic group, M¹, M²: metallic atoms of at least one kind or of different kinds, x: the valency of the metallic atom M¹, z: the valency of the metallic atom M², k: an integer higher than 2, m: an integer higher than 1, and n: a positive integer.

For example, in case of an inorganic polymer generated from phenyl trimethoxysilane represented by the following Equation 2, the unit molecular weight M of the inorganic polymer=137 and the molecular weight Rm of the organic group=77 so that the molecular ratio=77/137=0.562. That is, the molecular ratio of the organic group per the unit molecular weight of the inorganic polymer is represented by 56.2%.

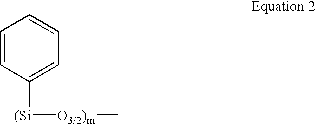

It was found that, in case of employing, as the organic high-molecular substance, an epoxy resin, an oxetan resin, an episulfide resin, or a mixed resin of two or more of these resins which uses amine as the hardener, as the amine is used as the hardener, the amine reacts with the glycidyl group of the epoxy resin so that the amine is contained in molecular backbones of the organic high-molecular substance and the amine which is basic also functions as the catalyst for the hydrolysis and polycondensation of the metal alkoxide compound, thereby effectively proceeding both the organic high-molecular yielding reaction and the hydrolysis and polycondensation reaction of the inorganic polymer. Since the amine is therefore combined and contained in the organic/inorganic composite optical material, there is no longer possibility of bleeding with time, thereby obtaining the organic/inorganic composite optical material which is extremely stable and has excellent durability.

When the inorganic polymer includes, in the organic group, many reactive functional groups, capable of interacting with the organic high-molecular substance to form a covalent bond therebetween, the metalloxane backbone in the inorganic polymer is reduced because such functional groups has relatively large molecular weight. Accordingly, the ratio of the metalloxane backbone in the organic/inorganic composite optical material is reduced, thus degrading the effect of inhibiting the thermal expansion contributed by the metalloxane backbone in the organic/inorganic composite material.

On the other hand, if the ratio of the inorganic polymer in the organic/inorganic composite optical material is increased not to reduce the ratio of the metalloxane backbone contained in the organic/inorganic composite material, the reactive functional group is also increased according to the increase in ratio of the inorganic polymer. When the organic/inorganic composite optical material is made by bonding and solidifying the organic high-molecular substance and the inorganic polymer in this state, internal stress may be created according to the solidifying reaction due to the large amount of the reactive functional group. In this case, cracking or the like may easily occur.

To avoid this trouble, it is needed to inhibit the bonding between the organic high-molecular substance and the inorganic polymer because of the large amount of the reactive functional group of the inorganic polymer. For this, methyl group and/or phenyl group of which molecular weight is relatively small is introduced, as a group which does not react with the organic high-molecular substance and thus does not form any bond, to the organic group of the inorganic polymer, thereby inhibiting the decrease in the ratio of the matalloxane backbone in the organic/inorganic composite optical material so as to improve the intersolubility between the organic high-molecular substance and the inorganic polymer. Therefore, the occurrence of cracks can be prevented.

The organic/inorganic composite optical material obtained in the aforementioned manner has high transparency and does not allow the occurrence of the light scattering and is therefore useful as a material suitable for optical elements.

Optical element such as a lens and a prism can be formed by pouring the organic/inorganic composite optical material before being hardened into a mold for cast molding, and hardening it. In addition, non-spherical configuration, a diffraction grating, or the like can be formed on a surface of an optical element such as an optical glass lens or prism by applying the organic/inorganic composite optical material before being hardened onto the surface of the optical element, pressing a mold against the surface of the optical element on which the organic/inorganic composite optical material is applied, and hardening the organic/inorganic composite optical material.

Hereinafter, the present invention will be described with reference to Examples of the present invention and Comparative Examples.

### EXAMPLE 1

9 parts by weight of epoxy resin of bisphenol A type represented by the following Equation 3 and 13.67 parts by weight of 3-glycidoxypropyltrimethoxysilane were mixed. After that, 2.84 parts by weight of tetraethylenepentamine was added to the mixture and agitated at a temperature of 0° C., and 1.56 parts by weight of water was added and further agitated for 1 hour, thereby obtaining homogeneous transparent liquid.

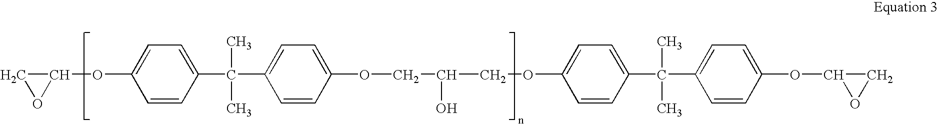

where n is 0 or 1 and the mean molecular weight is 380.

After vacuum defoaming of the obtained liquid, the liquid was poured into a mold having a lens configuration, and was left in an environment of 25±5° C. for 24 hours so as to obtain a transparent solid. The transparent solid was released from the mold and was heated at a temperature of 80° C. for 2 hours. In this manner, a lens made of the organic/inorganic composite optical material was obtained.

The obtained lens has a surface and a configuration which is transferred exactly from the surface and the configuration of the mold. That is, the moldability was good.

The ratio of the molecular weight of the organic group relative to the molecular. weight of the resulting inorganic polymer was 69%.

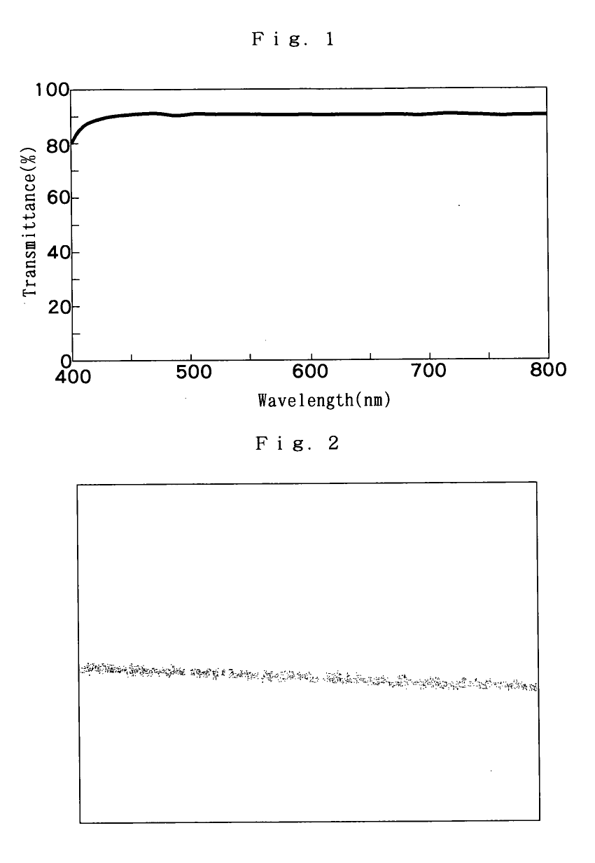

In addition, a parallel plate of 20 mm in diameter and 3 mm in thickness was also formed by using a mold in the same manner. The transparency of the parallel plate was measured by a spectrophotometer (U4000 available from Hitachi, Ltd.). As a result of this, a spectro-transmittance curve as shown in FIG. 1 was obtained, meaning that the parallel plate had good transparency. Further, the periphery of the parallel plate of 20 mm in diameter and 3 mm in thickness was partially cut away and polished to make a D-shaped specimen. The cut and polished face of the periphery was irradiated by an He—Ne laser (wavelength of 632.8 nm) of 20 mW and the optical track of the laser beam in the specimen was observed by a stereo microscope (SZX12 available from Olympus Optical Company limited) with 20-fold magnifying power. As a result of this, little track of the laser beam was observed as shown in FIG. 2. This means that no light scattering occurred due to collisions of laser beam in the specimen.

Evaluation results are shown in Table 1.

### EXAMPLE 2

9 parts by weight of epoxy resin of bisphenol A type represented by Equation 3 of Example 1, 6.94 parts by weight of 3-glycidoxypropyltrimethoxysilane, 2.91 parts by weight of phenyl trimethoxysilane, and 0.97 parts by weight of methyl trimethoxysilane were mixed. After that, 2.08 parts by weight of tetraethylenepentamine was added to the mixture and agitated at a temperature of 0° C., and 1.32 parts of weight of water was added and further agitated for 1 hour, thereby obtaining homogeneous transparent liquid.

After vacuum defoaming of the obtained liquid, the liquid was poured into a mold having a lens configuration, and was left in an environment of 25±5° C. for 24 hours so as to obtain a transparent solid. The transparent solid was released from the mold and was heated at a temperature of 80° C. for 2 hours. In this manner, a lens made of the organic/inorganic composite optical material was obtained.

The obtained lens has a configuration which is transferred exactly from the configuration of the mold similarly to Example 1. That is, the moldability was good. In addition, a parallel plate was also formed by using a mold in the same manner as Example 1. The spectro-transparency and the light scattering characteristic of the parallel plate when irradiated with laser beam were observed. As a result of this, the parallel plate had good transparency and no light scattering occurred. The ratio of the molecular weight of the organic group relative to the unit weight ratio of the resulting inorganic polymer was 64%.

Evaluation results are shown in Table 1.

### EXAMPLES 3 THROUGH 13

Organic/inorganic composite optical materials were prepared in the same manner as Example 1 except that the components of Example 1 are replaced by components shown in Table 1, and were evaluated in the same manner as Example 1. The results are shown in Table 1.

### COMPARATIVE EXAMPLE 1

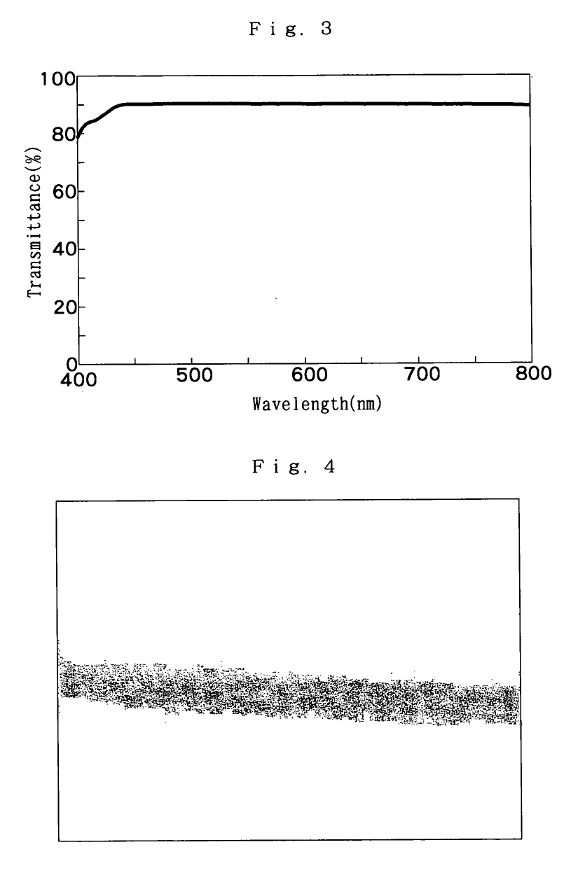

An organic/inorganic composite optical material was prepared in the same manner as Example 1 except that the components of Example 1 are replaced by components shown in Table 1. The transparency was measured in the same manner as Example 1. As a result of this, a spectro-transmittance curve as shown in FIG. 3 was obtained, and the other results are shown in Table 1.

### COMPARATIVE EXAMPLES 2 and 3

Organic/inorganic composite optical materials were prepared in the same manner as Example 1 except that the components of Example 1 are replaced by components shown in Table 1, and were evaluated in the same manner as Example 1. The results are shown in Table 1.

### COMPARATIVE EXAMPLE 4

7.8 parts by weight of tetramethyl orthosilicate was added to 14 parts by weight of epoxy resin the same as used in Example 1, 1.84 parts by weight of water was further added, tetramethylepentamine of which mass ratio relative to the epoxy resin was 190:27 was furthermore added, and mixed and agitated to cause the polycondensation reaction, thereby obtaining a composition including an inorganic component of 14 mass % in terms of silicon dioxide.

After the obtained composition was poured in a mold and was left at a temperature of 25° C. for 24 hours, it was heated at a temperature of 80° C. for 2 hours, thereby obtaining an organic/inorganic composite optical material.

A measurement specimen was prepared from the obtained organic/inorganic composite optical material in the same manner as Example 1. A cut and polished face of the periphery of the specimen was irradiated by an He—Ne laser (wavelength of 632.8 nm) of 20 mW and the optical track of the laser beam in the specimen was observed by the stereo microscope with 20-fold magnifying power. As a result of this, track of the laser beam was clearly observed as shown in FIG. 4. This means that light scattering occurred.

TABLE 1

| | | | | | | | | Ratio(%) | | |
|---|---|---|---|---|---|---|---|---|---|---|
| | Components (parts by weight) | | | | | | | of organic | Evaluation | |
| | EPOXY | TEPA | GP silane | Ph silane | Me silane | T silane | Water | group | Transparency | Scattering |
| Example 1 | 9.00 | 2.85 | 13.67 | 0.00 | 0.00 | 0.00 | 1.56 | 69% | Excellent | Excellent |
| Example 2 | 9.00 | 2.08 | 6.94 | 2.91 | 0.97 | 0.00 | 1.32 | 64% | Excellent | Excellent |
| Example 3 | 3.53 | 1.85 | 11.80 | 0.00 | 0.00 | 0.00 | 1.35 | 69% | Excellent | Excellent |
| Example 4 | 9.61 | 1.91 | 4.72 | 0.00 | 0.00 | 0.00 | 0.54 | 69% | Excellent | Excellent |
| Example 5 | 16.11 | 4.73 | 21.24 | 1.98 | 0.00 | 0.00 | 2.70 | 68% | Excellent | Excellent |
| Example 6 | 13.87 | 4.00 | 17.70 | 0.00 | 1.65 | 0.00 | 2.25 | 67% | Excellent | Excellent |
| Example 7 | 21.20 | 16.51 | 118.00 | 99.00 | 0.00 | 0.00 | 27.00 | 65% | Excellent | Excellent |
| Example 8 | 32.68 | 12.66 | 70.80 | 138.60 | 0.00 | 0.00 | 27.00 | 63% | Excellent | Excellent |
| Example 9 | 12.59 | 2.87 | 9.44 | 2.64 | 2.64 | 0.00 | 1.80 | 63% | Excellent | Excellent |
| Example 10 | 14.53 | 3.52 | 12.71 | 0.00 | 4.57 | 0.00 | 2.08 | 62% | Excellent | Excellent |
| Example 11 | 20.10 | 3.40 | 4.72 | 15.84 | 0.00 | 0.00 | 2.70 | 62% | Excellent | Excellent |
| Example 12 | 38.91 | 8.77 | 28.32 | 3.96 | 11.88 | 0.00 | 5.40 | 61% | Excellent | Excellent |
| Example 13 | 19.68 | 4.42 | 14.16 | 0.99 | 6.93 | 0.00 | 2.70 | 60% | Excellent | Good |
| C. Ex. 1 | 19.99 | 4.46 | 14.16 | 0.00 | 7.92 | 0.00 | 2.70 | 59% | Excellent | Not Good |
| C. Ex. 2 | 7.03 | 1.45 | 3.93 | 0.00 | 3.30 | 0.00 | 0.90 | 56% | Good | Not Good |
| C. Ex. 3 | 20.79 | 4.31 | 11.80 | 1.98 | 0.00 | 6.08 | 2.70 | 56% | Not Good | Not Good |

C. Ex. = Comparative Example
In Table 1:
EPOXY: epoxy resin of bisphenol A type represented in Example 1
TEPA: tetraethylenepentamine
GP silane: 3-glycidoxypropyltrimethoxysilane
Ph silane: phenyl trimethoxysilane
Me silane: methyl trimethoxysilane
T silane: tetramethyl orthosilicate

As you can see from Example 13 and Comparative Example 1, as a part of methyl trimethoxysilane is replaced by phenyl trimethoxysilane, the light scattering characteristic is significantly improved in the light scattering evaluation using laser beams. This means that there is an effect contributed by the interaction between the phenyl group and a group in the organic high-molecular substance and that the effect contributed by the ratio of the molecular weight of the organic group relative to the molecular weight of the inorganic polymer when the ratio is 60% or more is larger than that when the ratio is 59%.

The organic/inorganic composite optical material obtained by the present invention is prepared by using an inorganic polymer having a functional group capable of being chemically bonded with a functional group of an organic high-molecular substance which has a heat resistance and large mechanical strength just like an epoxy resin. Therefore, since the organic/inorganic composite optical material has excellent transparency as well as the heat resistance and the mechanical strength, does not allow the light scattering, and has excellent moldability, it can be suitably used for various optical elements such as lenses, prisms, filter substrates, and diffraction optical elements.

What we claim is:

1. An organic/inorganic composite optical material comprising an organic high-molecular substance and an inorganic polymer which is prepared by the polycondensation of a metal alkoxide compound, wherein the metal alkoxide compound includes a functional group capable of interacting with the organic high-molecular substance or a monomer/oligomer generating the organic high-molecular substance to form a chemical bond therebetween.

2. An organic/inorganic composite optical material as claimed in claim 1, wherein the ratio of the molecular weight of the organic functional group relative to the molecular weight of the inorganic polymer prepared by the polycondensation of the metal alkoxide compound is 60% or more.

3. An organic/inorganic composite optical material as claimed in claim 1, wherein the organic high-molecular substance is epoxy resin of bisphenol A type and the organic group in the inorganic polymer includes at least one of a glycidyl group, an oxetanyl group, an amino group, a thiocidyl group, a vinyl group, a phenyl group, and an alkyl group.

4. An organic/inorganic composite optical material as claimed in claim 2, wherein the organic high-molecular substance is epoxy resin of bisphenol A type and the organic group in the inorganic polymer includes at least one of a glycidyl group, an oxetanyl group, an amino group, a thiocidyl group, a vinyl group, a phenyl group, and an alkyl group.

5. An optical element made of an organic/inorganic composite optical material, wherein the organic/inorganic composite optical material is the organic/inorganic composite optical material as claimed in claim 1.

6. An optical element made of an organic/inorganic composite optical material, wherein the organic/inorganic composite optical material is the organic/inorganic composite optical material as claimed in claim 2.

7. An optical element made of an organic/inorganic composite optical material, wherein the organic/inorganic composite optical material is the organic/inorganic composite optical material as claimed in claim 3.

8. An optical element made of an organic/inorganic composite optical material, wherein the organic/inorganic composite optical material is the organic/inorganic composite optical material as claimed in claim 4.
